(19) United States
(12) Patent Application Publication
(10) Pub. No.: US 2017/0306577 A1
(43) Pub. Date: Oct. 26, 2017

(54) AUTOMATIC LIGHTING SYSTEM OF THE TRANSVERSAL MARKING FOR CROSSING OF THE PEDESTRIAN WALKWAYS

(71) Applicant: Adrian-Ionut TRIFAN, Tulcea cod (RO)

(72) Inventor: Adrian-Ionut TRIFAN, Tulcea cod (RO)

(21) Appl. No.: 15/527,831

(22) PCT Filed: Nov. 17, 2015
(86) PCT No.: PCT/RO2015/000025

§ 371 Date: May 18, 2017

(30) Foreign Application Priority Data
Nov. 20, 2014 (RO) A 2014 00896

(51) Int. Cl. E01F 9/582; F21V 23/04; F21V 3/00; F21S 9/03; F21S 8/00; F21V 31/00; F21Y 2115/10

(52) U.S. Cl. CPC E01F 9/582; F21V 31/005; F21V 23/0485; F21V 23/0471; F21V 23/0464; F21V 3/00; F21S 9/032; F21S 8/032; F21Y 2115/10

(57) ABSTRACT

The invention refers to a lighting automatic system for pedestrian crossing and to a method of making the markings for the pedestrian crossings. The system comprises several lighting units sank in the asphalt made of a box (2) welded by a netting (11) fixed on the bottom of the hole made for the mounting of the lighting units, the box (2) having an external frame (5) and being closed with a detachable cap (4) equipped with a window in which a protection frame is fixed (6) of a piece made of safety glass (8), the cap representing the transversal marking of the pedestrian crossing, in the interior of the box (2) being a LED lighting unit (1) powered by a net or a photovoltaic plant (14) mounted on a pile (17) in the proximity of the pedestrian crossing, on the surface of the cap (4) being poured bitumen subsequently painted with reflecting painting, so that the glass (8) in the mounted state of the system, to be at the level of the roadway (10).

This invention refers to traffic safety facilities, light transversal marks for the pedestrian crossings. More precisely, the current invention refers to an automatic light system of the transversal markings for crossing for the pedestrian walkways and to a process of making the transversal markings for crossing for the pedestrian walkways.

The low visibility during night, the snow during winter, the insufficient signalizing of the pedestrian crossings, as well as the fact that some drivers are blinded during the night by the lights of other traffic participants, turn a lot of traffic accidents to have as casualties the pedestrians who were crossing.

A solution to this issue is the intelligent systems of light adopted for the pedestrian crossings.

The paper RO91625 and RO 125804 B1 reveal examples of automatic signalizing devices for the pedestrians' presence in the close vicinity or on the pedestrian crossing, by using various lighting devices, activated by sensors.

In addition, there are also known right from the technical stage various technical solutions for signalizing during night/fog of the crossings/traffic lanes, by using buried or mounted over the road lighting devices (see, for instance, WO2011129517 A2, U.S. Pat. No. 6,384,742 B1, RU2012118722 A).

It is also known that marking the pedestrians' crossings represents an activity regulated at European level (in Romania by the Standard SR 1848-7:2004). This standard mention at General Provisions (see point 1.2) that the markings “must not disturb in any way the traffic and must not present slippery surface”. Moreover, the same standard enforces that, for the pedestrian crossings, the transversal (white) strips must be 40 cm wide, and the space between two strips must be of 60 cm.

For instance, another solution is described in the Paper JP 2001109995 A referring to a lighting system of a pedestrian crossing by using light devices buried at road level. Each light device is formed of a box with LED-s inside, the upper part of the box being of transparent plastic material in order to allow for the lighting of the pedestrians who are crossing. The Led-s turning on and the lighting of the pedestrian crossing occur depending on various types of sensors of presence/pressure installed on the sidewalk. Despite providing for an efficient control of the lighting of the pedestrian crossing, the solution revealed in the Paper JP 2001109995A has some major disadvantages as it breaches right the general provisions of the Standard SR -1848-7-2004 mentioned above.

More precisely, the manufacturing of the upper side of the box from a board of plastic material 40 cm wide and 3-4 m long (as stipulated by the same Standard) is, not only on rainy weather, a very slippery surface both for the pedestrians, and for the vehicles, the lid length being larger that the width of a vehicle wheel, therefore the adherence being much more lower. In addition, the resistance insured by the board of plastic material for the heavy traffic (for instance, a maximal mass of each axis of 9 tons) or its capacity to remain transparent in terms of intense contact with abrasive materials are also noticeable disadvantages. Moreover, the Paper JP 2001109995 A does not reveal and does not suggest how the access to the inside of the box is provided in case of maintenance operations, nor it does mention the factual proceeding to bury the boxes of the lighting devices.

The main object of the current invention is to provide for an improved solution related to the provisions of the Paper JP 2001109995 A, especially with regard to an increased robustness of the lighting bodies, even for the heavy traffic, to an increased safety both for the pedestrians and for the vehicles crossing over the marking achieved according to the current invention, and not lately for lesser time for installing it.

Another objective of the current invention is to provide an automatic lighting system of the transversal markings for the pedestrians' crossings and the process to manufacture the transversal crossing markings for more economic crossings.

A supplementary objective of the current invention is to provide for an automatic lighting system of the transversal marks for crossing for the pedestrians' crossings and a process to produce the transversal crossing marks for the pedestrians' walkways which to respect the provisions of the Standard SR 1848-7:2004.

These objectives are achieved with an automatic lighting system of the transversal markings of the pedestrians' crossings which has the technical characteristic for the independent claim 1 and with a process for manufacturing the transversal crossing marks for pedestrians' walkways according to the independent claim 7.

The preferred examples for achieving the invention are formulated in the enclosed dependent claims.

The system in accordance with the current invention will prove its efficiency at the pedestrians' crossings which are weakly illuminated or even without light, at the pedestrians' crossings at the curve, during winter, when the markings are covered by snow, and on the roads with several traffic lanes on one way, where, in case there are vehicles in traffic on all lanes of a way their visibility at a pedestrian crossing is a lot diminished because of the other cars, the light of the transversal marks pointing them out that there is a pedestrian in crossing without even being needed to see the respective pedestrian.

According to the invention, the automatic lighting system of the transversal markings for the pedestrian crossing is formed of lighting metallic bodies, endowed with an ensemble of illumination by LED technology, which are introduce under the location of the previous pedestrian crossing by stripping the road. The lighting bodies are welded to a reinforcing steel net, placed on the bottom of the ditch stripped in the asphalt. The metallic lighting bodies have on the lid a central cut, and above it secured frosted glass (to prevent the reflection of the light during the sunny days), glass through which the illumination of the transversal marking is performed, and, implicitly, the lighting of the pedestrian's silhouette. A layer of asphalt bitumen is poured on the lid of the metallic lighting device, which is painted in reflectorizing paint as according to the European Standard in the area. Consequently, the lid of the metallic device turns into transversal marking of the pedestrian crossing. These metallic lighting devices, welded on the reinforcement net and connected to the electric network and to a sensors network are buried in the road. During night, the twilight sensor will open the electric circuit of the system allowing that, when a pedestrian steps on the weight sensors on the sideway and/or interrupts the laser rays of the laser barrier, the system becomes active by lighting the transversal markings of the pedestrian crossing. Consequently, the crossing transversal markings will light on, warning the drivers on the existence of a pedestrian crossing, on pedestrians' existence who are crossing the street by lighting their silhouettes or on a person's intention to cross, therefore allowing them to take the necessary measures in time (breaking, reducing the speed, stopping, etc.). In a certain time delay, after crossing the street, the automatic lighting system stops, warning the drivers that there is no person intending to cross the street or in process of crossing the walkway. The activation of the weight sensors and of the laser barriers will provide enough time for light signal, for safety crossing of the pedestrian walkway.

According to the invention, the automatic lighting system of the transversal crossing markings for the pedestrian walkways and the process to manufacture the transversal crossing marking for the pedestrian walkways have the following advantages:
Easy and quick installation of the system without blocking the traffic for too long;
It is an economic system with low costs of installation, maintenance and exploitation;
It provides better visibility of the pedestrian crossing by lighting up the transversal markings;
It provides better visibility of the pedestrians in crossing process by lighting on their silhouettes;
It warns the drivers on the presence of a person in crossing the walkway by automatic lighting of the transversal markings, lighting which starts when the sensors sense the person's presence and the person's intention to cross the street, in the vicinity of the crossing.

Further, there is an example which is just illustrative and not limitative on how to produce the automatic lighting system of the transversal crossing markings for the pedestrian walkways and on the process of doing them according to the invention, in relation with the attached images, indicating:

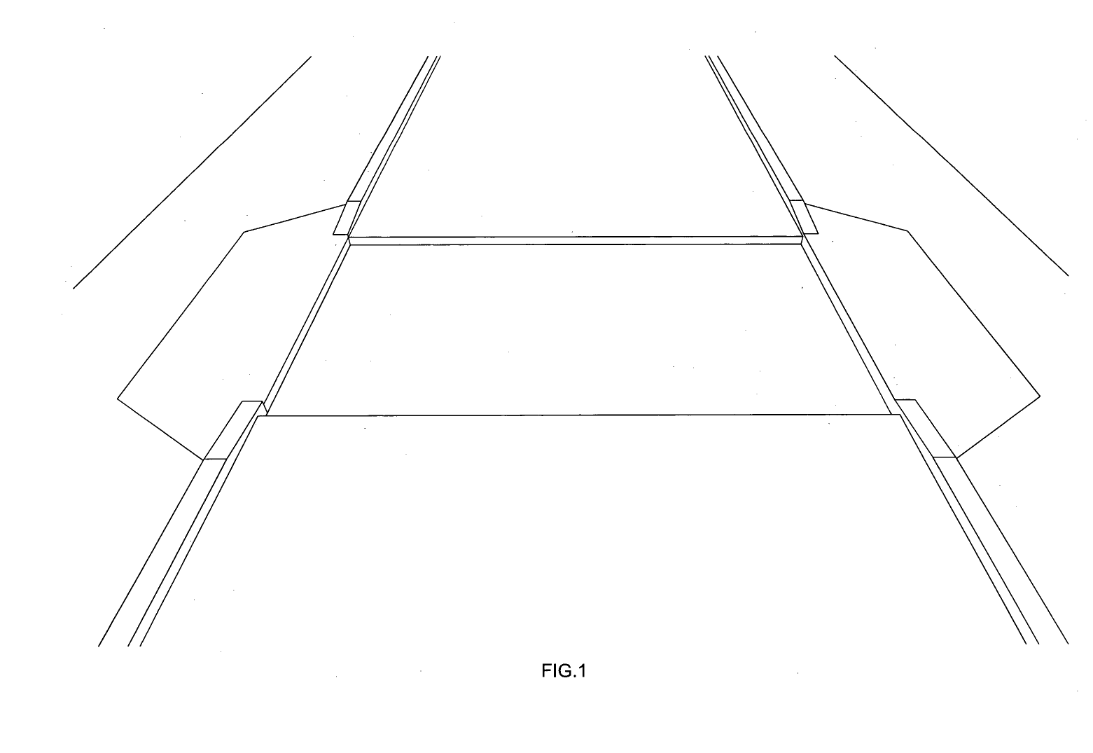

FIG. 1—Stripped road view

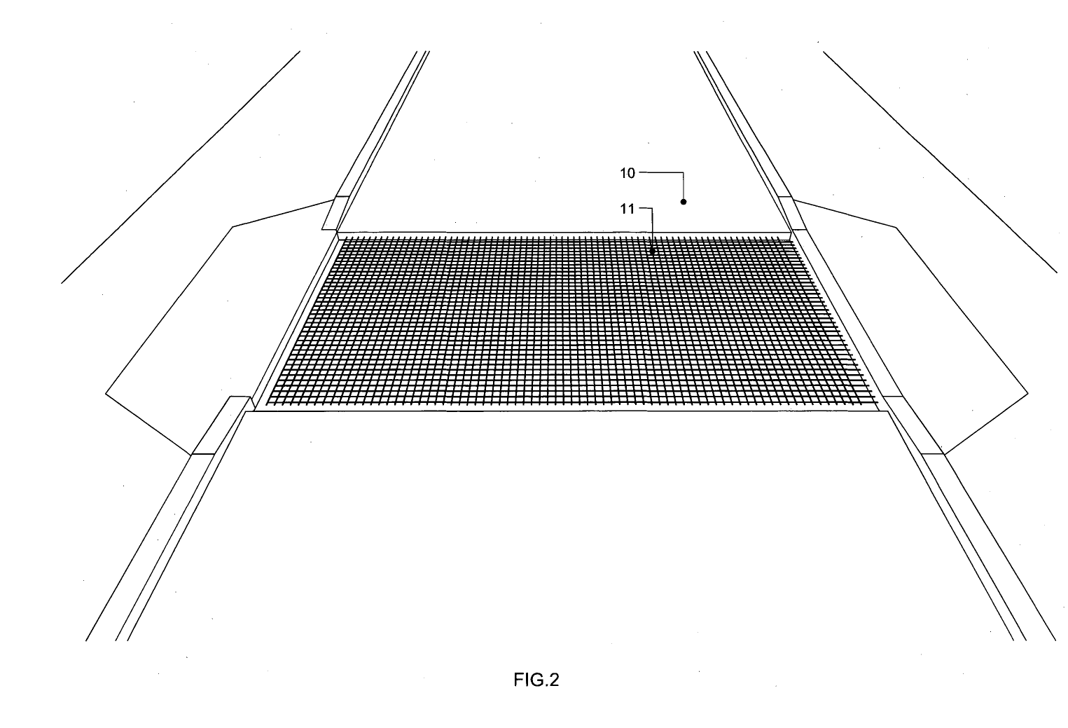

FIG. 2—View of the reinforced steel net mounted and fixes at the bottom of the stripped ditch

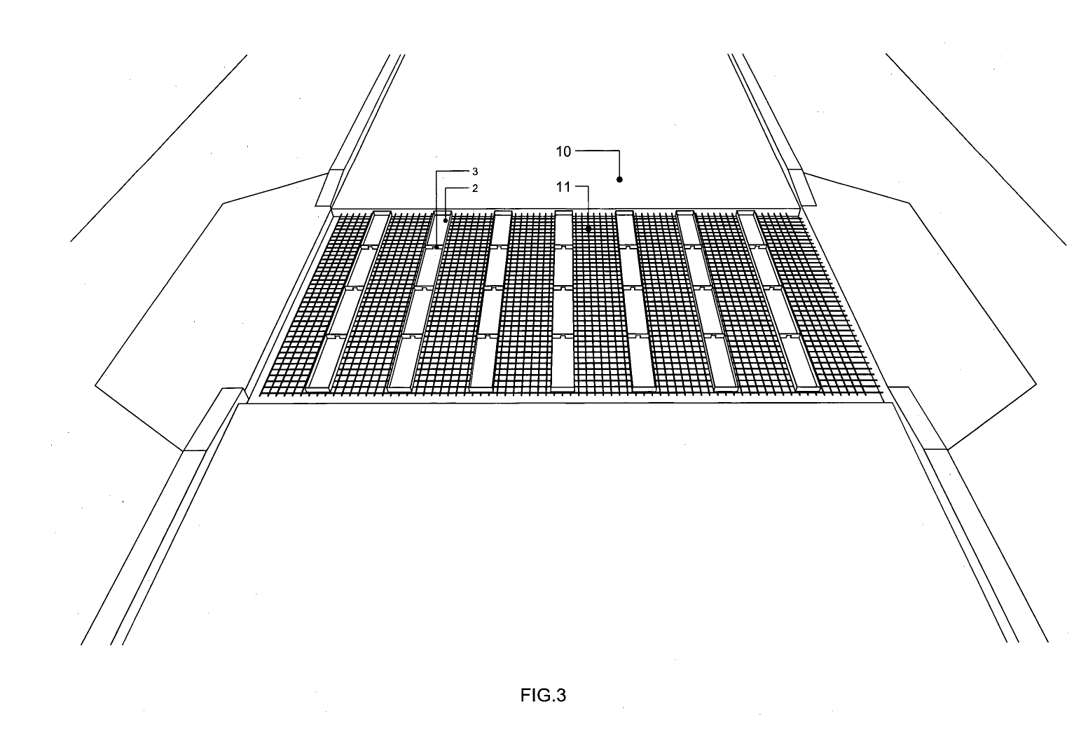

FIG. 3—View of the metallic lighting boxes, welded on the reinforced steel net

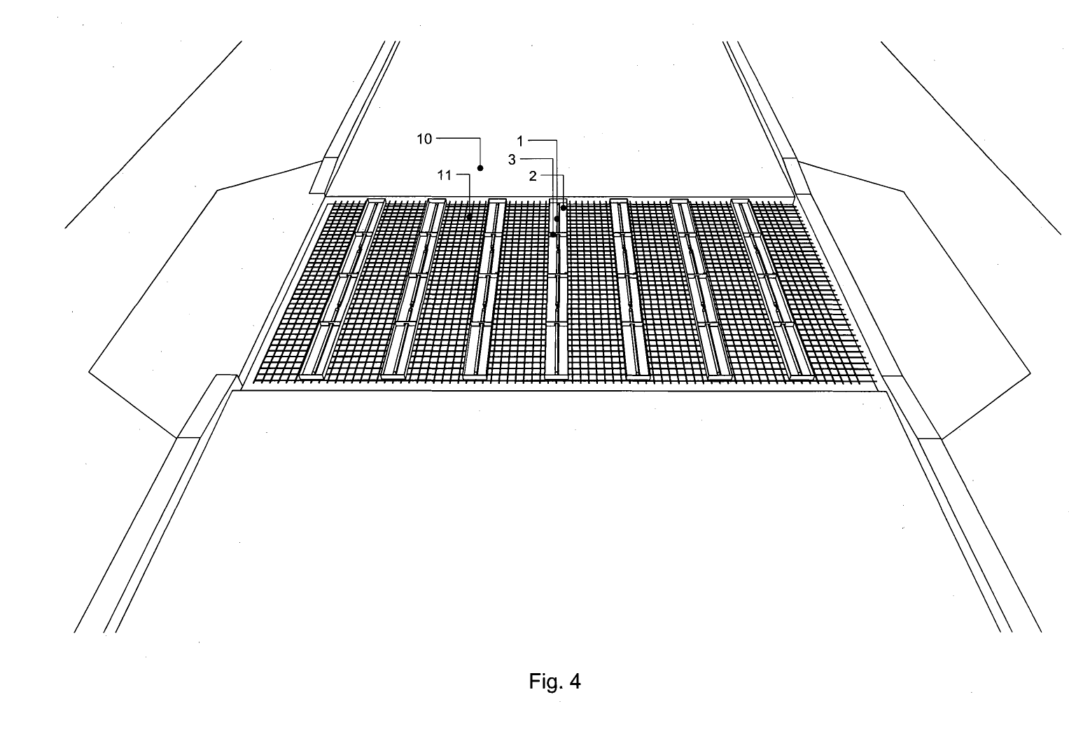

FIG. 4—View of the metallic lighting boxes equipped with the LED light system

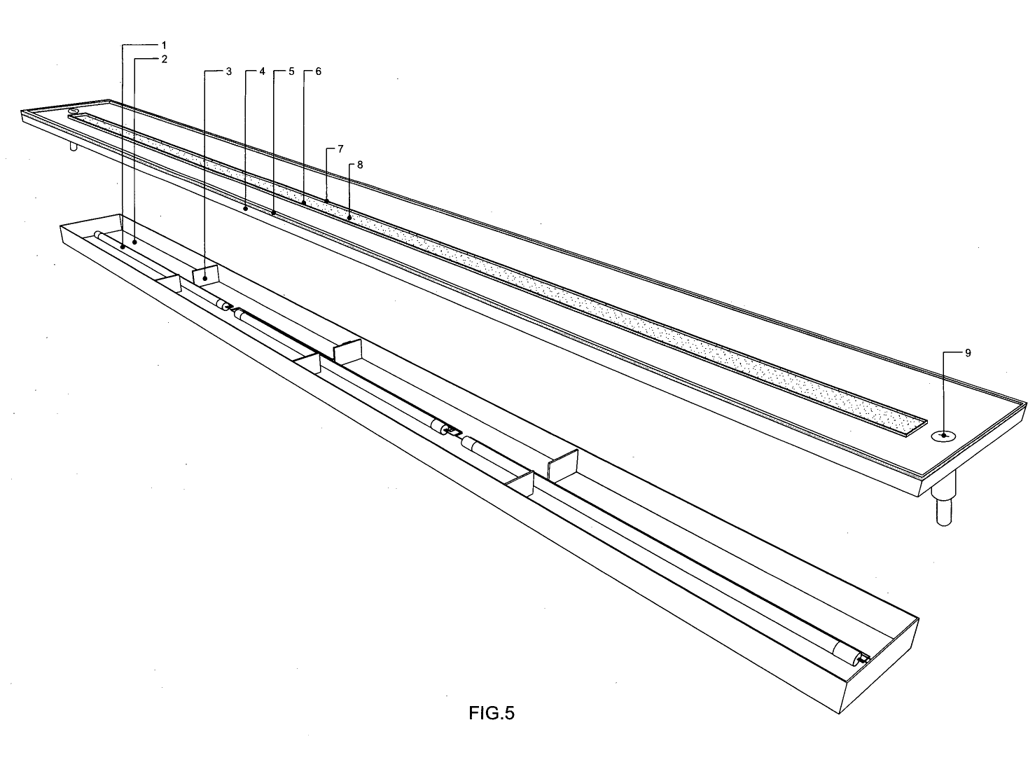

FIG. 5—View of the metallic lighting device equipped, without asphalt bitumen on the lid

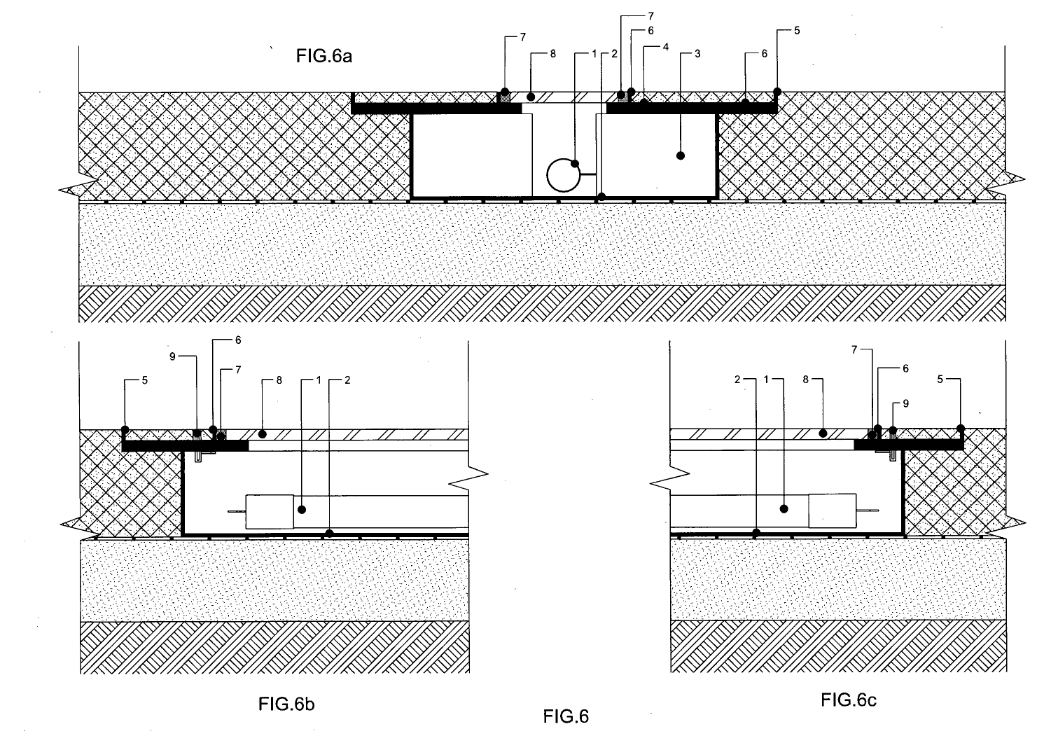

FIG. 6a-6c—Views in transversal and longitudinal sections of the metallic body buried in the asphalt bitumen

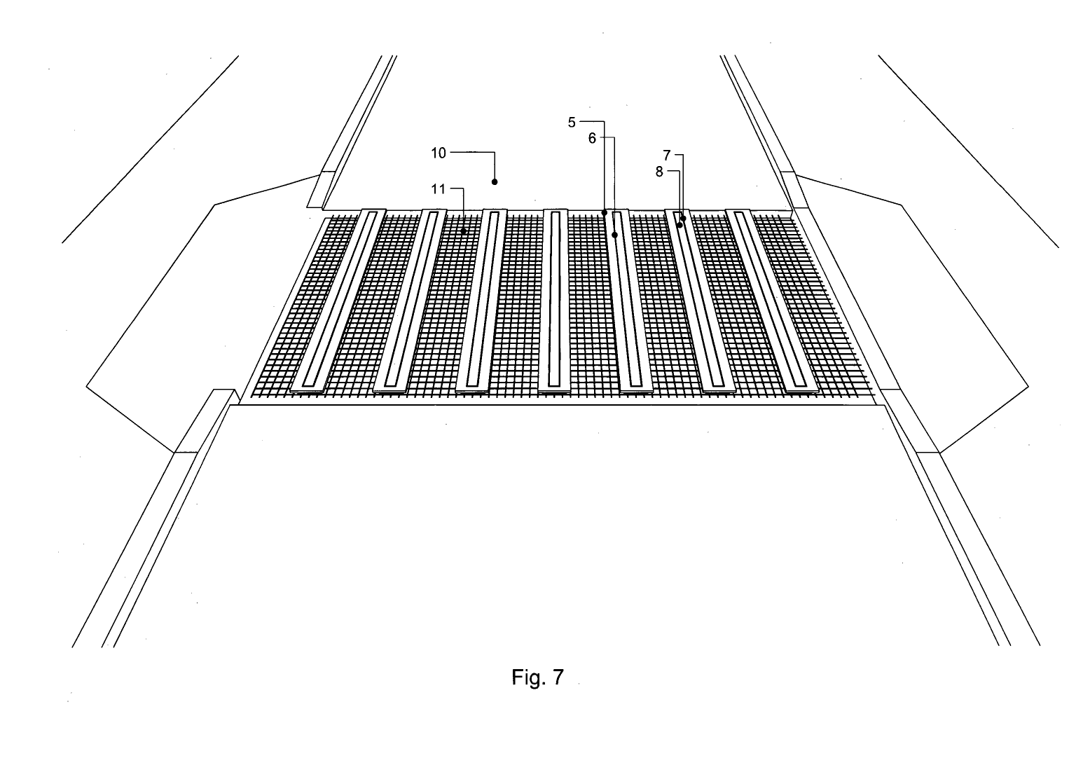

FIG. 7—View of the metallic lighting devices, totally equipped and welded on the reinforced steel net

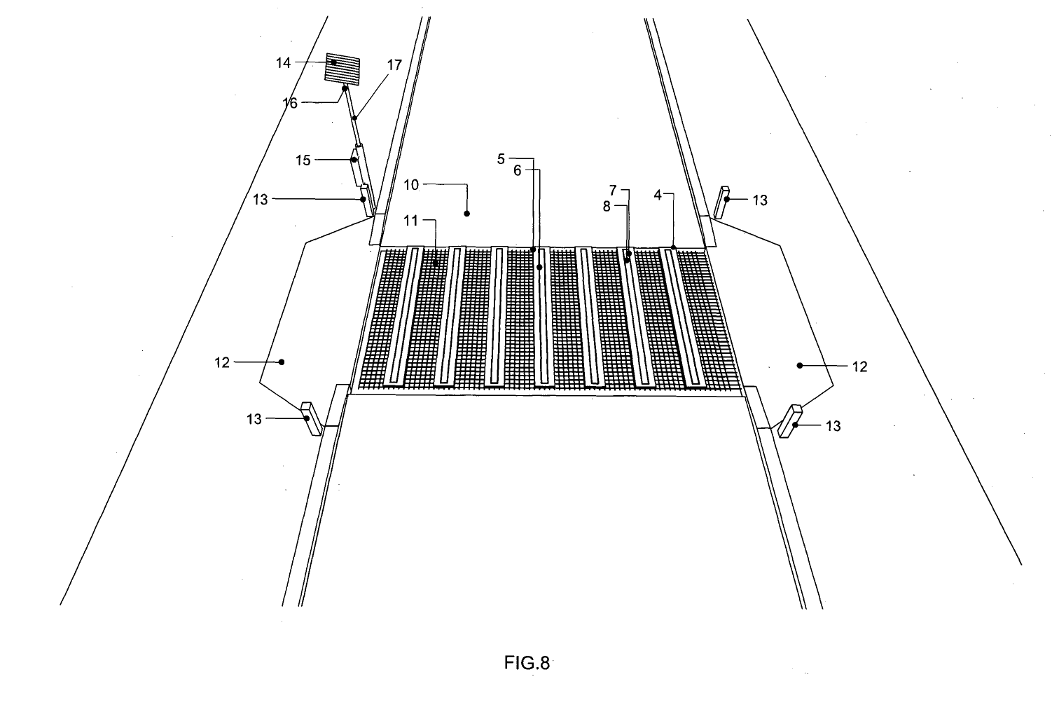

FIG. 8—View of the automatic lighting system of the transversal marking for pedestrian walkways, equipped with metallic lighting devices, sensors, and system of photovoltaic panels not buried into the asphalt bitumen

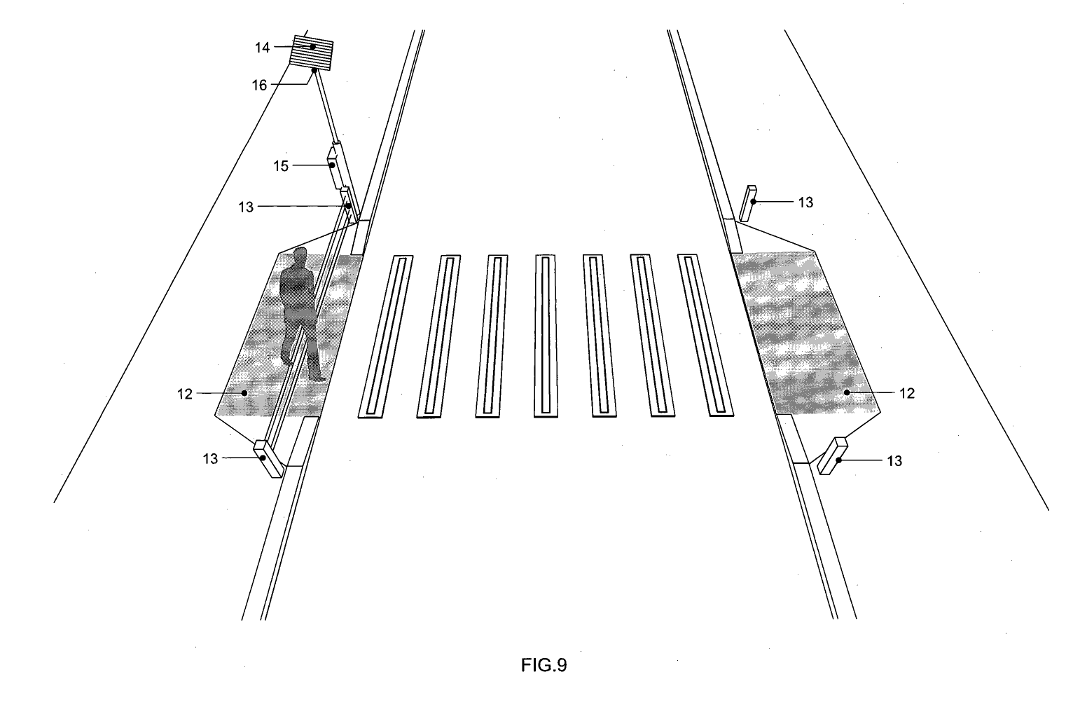

FIG. 9—View automatic lighting system of the transversal markings for the pedestrians' walkways fully installed and covered by asphalt bitumen

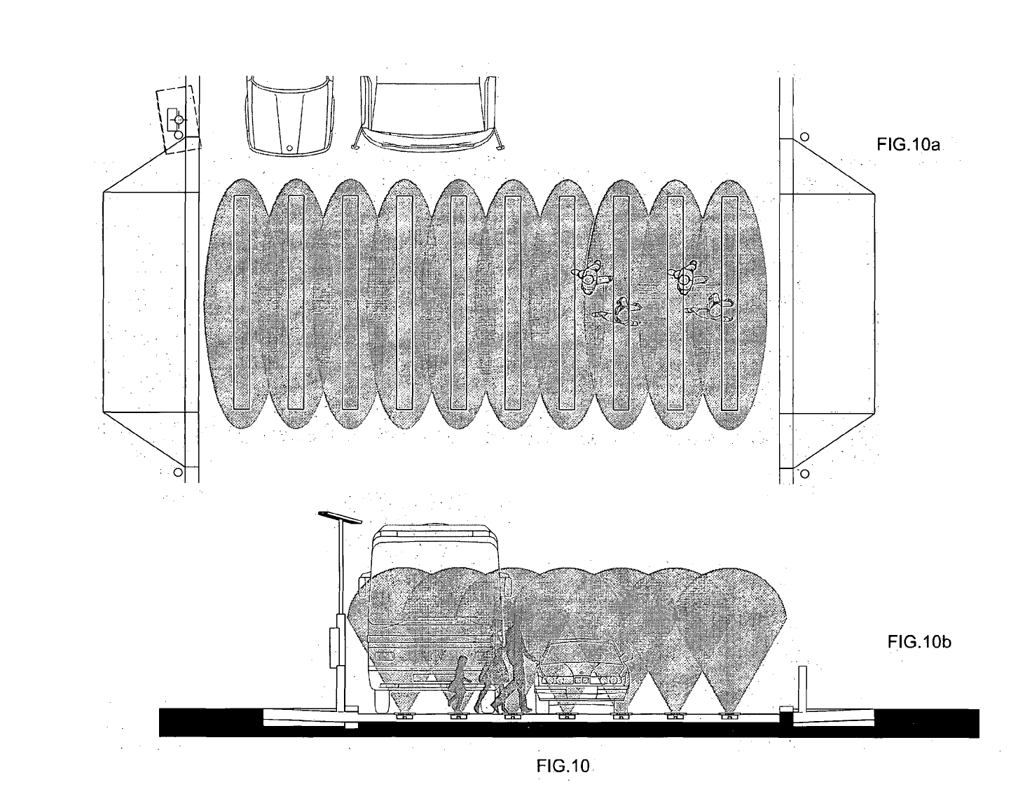

FIGS. 10a, 10b —Example of lighting of the pedestrian crossing and of the pedestrians' silhouette-side and above views

According to the invention, the system of automatic lighting of the transversal crossing markings for the pedestrians' crossings, presented in FIG. 9, comprises:

In FIG. 5, the metallic lighting device can be noticed, formed of a rectangular metallic box 2 of steel sheet, having on the bottom welded elements of resistance 3 for supporting the vehicles loads, a rectangular lid 4 of thick steel sheet to resist the high loads of the vehicles. This lid of the metallic light device has an opening cut in the center of it on which the frozen secured glass is to be stuck 8 and a cord of silicone putty 7 is to be used in order to insulate the metallic light body against the water infiltrates. In FIG. 6a—the upper section—we can see the lid of the lighting device 4 which has welded two steel sheet frames, one on the edge f the lid 5, and the other centrally around the lid cut 6, with role of protection of the secured glass 5. Both steel sheet frames have the same height as the frozen secured glass. A layer of asphalt bitumen is to be applied between the two welded frames 5 and 6, thick as the height of the two frames which will be painted with reflectorizing paint afterward as provided by the European Standard in the area. Consequently, the lid of the box turns into the transversal marking of the pedestrian crossing like in FIG. 7. The lid of the light device 4 has the standard length and width of the transversal crossing marking for the pedestrian crossing as stipulated by the European legislation in the area. The lid of the metallic light device 4 has two systems of closing 9 with the help of which the access inside the metallic light device of the unauthorized persons and it could be used for lifting the lid in case of malfunctions occurred at the lighting ensemble LED 1, see FIG. 5.

The lighting LED 1 ensemble will light through the cut of the lid and through the frozen secured glass 8, the transversal crossing mark of the pedestrian walkway which is represented by the lid of the metallic box of the light device represents, see FIG. 5. The light ensemble 1 is to be caught with special hooks on the bottom of the metallic light box 2 and will have tubes with LED technology or LED band.

The frozen secured glass 8 has the role of optic element, protecting the light ensemble LED 1 and the inside of the light metallic device from the external factors. A cord of silicone putty 7 is to be poured between the metallic frames for protection of the glass 6 and the frozen secured glass 8 in order to insulate the metallic light device against the water infiltrations, see FIG. 6. The secured glass is to be frozen on the surface for preventing the light reflection during sunny days.

The reinforced steel net 11 is a special steel net, used to reinforce and fix the ensemble formed of metallic light devices in order to increase the reinforcing surface and to stabilize the tension forces occurred after the asphalt layer, as seen in the FIG. 2. This reinforced net 11 is necessary because the buried height of the light metallic devices is very low, and so it is their weight, the net reinforcement stabilizing the weight forces which act on the entire system.

The pressure sensors 12 have the role to automatically start the light ensemble LED 1 of the light metallic device. The moment when a pedestrian applies a pressure (steps) on these sensors 12 like in the FIG. 9, the light ensembles LED 1 of the metallic light devices will automatically start the lighting of the transversal markings, warning the drivers on the intent of crossing from a pedestrian or the presence on the pedestrian crossing of a person engaged in crossing the street and will light one's silhouette during the action. This system is to be used also a back-up system in case of malfunction of the laser barrier and vice versa.

Laser sensors (laser barriers) 13 have the role of automatically starting the light ensemble LED 1 of the light metallic box. The interruption of the laser beams of the barrier caused by a pedestrian crossing among the pillars of the laser barrier as in FIG. 9 will automatically start the light ensembles LED 1 of the light metallic devices which will light the transversal markings, warning the drivers on a pedestrian's intention to cross the street or on a pedestrian's presence on the crossing and will light the person's silhouette during the crossing.

The twilight sensor (the light sensor) 16 represented in the FIG. 9 will open the electric circuits of the LED light ensembles 1 of the metallic light devices at night. This sensor could be set to start the automatic lighting system of the transversal marking for the pedestrian walkways at various intensities of the natural light.

The photovoltaic supply installation 14 represented in FIG. 9 is to be used at interruption in the power supply of the local energy network, but also when the technical solutions do not allow the connection of the system to the local energy network (isolated areas).

The electric panel 15 represented in FIG. 9 comprises the electrical and command parts of the automatic light system of the transversal marking and the accumulators of the photovoltaic installation.

According to the invention, the automatic light system of the transversal crossing markings for pedestrian walkways is formed of metallic light devices, equipped with lighting ensemble with LED technology 1, introduced below the location of the old pedestrian crossing by stripping of the road like in FIG. 9.

The boxes of the metallic light devices are welded on a reinforced steel net 11, places on the bottom of the stripped ditch in the asphalt like in FIG. 3. The optical element of the metallic light devices is formed of the central cut in the lid and the frozen secured glass 8, stuck on this central cut of the lid. By this optical element, highlighted in the FIG. 5, the lighting of the transversal marking is performed and, consequently, the lighting on the pedestrians' silhouettes occurs. A layer of asphalt bitumen is poured on the lid of the metallic light device 4 which, later on, is painted with reflectorizing paint as stipulated in the European Standard in the area. The boxes of the metallic light devices welded by the metallic net 11, equipped with the LED light ensemble 1 are to be connected to the electric network and to a sensors network 12, 13, and 16 like in the FIG. 8.

After these operations, the lids of the metallic light bodies 4 are closed and equipped with frozen secured glass 8 like in FIG. 6.

We can see in FIG. 9 how all this constructed ensemble is to be buried in asphalt bitumen until the height of the external frames of the lids of the light devices 5, which are at the same level with the road 10.

So, the cap of the lighting metallic unit 4 equiped with sandblasted tempered glass 8 becomes the transversal illuminated marking of the pedestrian road crossing.

In the FIG. 9 it can be observed that by nightfall, the crepuscular sensor 16 will open the electrical circuit of the system allowing when a pedestrian steps on the pressure sensors 12 located on the sidewalk and/or interrupts the laser beam barrier 13 the system becomes active by illuminating the transversal marking of the pedestrian crosswalk.

In the FIG. 9 it is shown how the crossing transversal marking will light up and illuminate the silhouettes of the persons engaged in crossing the street on the pedestrian crosswalk, warning the drivers about the existence of the crosswalk, about the pedestrian engaged in road crossing or about the pedestrian intention to cross the road, allowing the driver to take the appropriate actions (breaking, speed reducing, stopping, etc.). After pedestrian cross, at a certain period, the automatic lighting system of the transversal marking will stop, informing the drivers that no person has the intention to cross or is engaged in crossing the crosswalk. The period of time for each pressure sensors activation 12 and of the laser beam barrier 13 will be set up by a timer, allowing a sufficient lighting time of the transversal marking, for safe crossing of the crosswalk even for persons with disabilities.

The system can be powered up by night time using the batteries of the photovoltaic system 14.

Setup Metode.

The asphalt will be stripped out on all length and width of the old crosswalk, as shown on FIG. 1

In FIG. 2 it can be seen on the bottom of the pit formed in this way how nets of steel for reinforcing 11 are stretched and fixed, on witch it will be welded the boxes of the metallic lighting units 2.

In FIG. 3 it can be seen how the boxes of the metallic lighting units 2, which have the standard length of the transversal markings for the pedestrian crossings provided by the European laws in the field, will be welded on the reinforcing steel net 11 at the STAS distance provided by the same legislation. The welding from the steel net is necessary for stabilizing the forces of tension and weight of the system.

After this operation the boxes of the metallic lighting unit 2 equipped with the LED 1 lighting assembly will be connected in parallel trough the electrical wiring to the switchboard panel 15 and to the sensor system 12, 13 and 16. The electrical wiring will be protected by the Copex metal tubes.

After the above operations, we will start the installation of sensors 12, 13 and 16, of the photovoltaic power plant 14 and of the switchboard panel 15 as seen in FIG. 8, as follow:

In FIG. 8 it can be seen that the pressure sensors 12 will be installed under ceramic or concrete plates disposed in the area of the crosswalk, on both sidewalks.

In FIG. 8 it can be seen that the laser barriers (laser sensors) 13 will be installed on both sidewalks, all through the width of the crosswalk, near the crimps.

In FIG. 8 it can be seen that the crepuscular sensor (sunlight sensor) 16 will be installed on the metallic pole 17 which will hold the photovoltaic installation 14.

In FIG. 8 it can be seen that the photovoltaic installation 14 will be mounted on the metallic pole 17 located on one of the sidewalks near the crosswalk.

In FIG. 8 it can be seen that the switchboard panel 15 will be mounted on the metallic pole 17 of the photovoltaic installation.

After all these operations the caps of the metallic units will be mounted and closed 4 equipped with the sandblasted tempered glass 8. It will be poured asphaltic bitumen on top of the lighting metallic unit 4 between the exterior frame, 5 and the protection frame 6 of the sandblasted tempered glass for a good grip of the cars tires—see FIG. 6a—above section. As we can see in FIG. 5 although not presented in the scale, the strip of the sandblasted tempered glass 8, represents less then ⅓ of the total length of the cap 4, with a length of 10-13 cm. this dimension represents less than the width of a tire for a adequate grip. The asphaltic bitumen poured on the cap between the exterior frame 5 of the cap 4 of the lighting metallic unit, the interior protection frame 6 of the glass will be painted entirely in accordance with the European Standards and will be the transversal marking of the crosswalk. As you can see in FIG. 9, the entire explained in FIG. 8, will be buried in bitumen till the level of the external frames of the lighting unit 5, at the same level with the road 10, becoming functional for both cars and pedestrians.

LIST OF REFERENCES

| NR. | |
|---|---|
| CRT | NAME |
| 1. | LED Lighting kit |
| 2. | Lighting metallic unit |
| 3. | Reinforcing elements |
| 4. | Cap lighting metallic unit |
| 5. | Frame cap lighting metallic unit |
| 6. | Protection frame for tempered glass |
| 7. | Silicone kit belt |
| 8. | Sandblasted tempered glass |
| 9. | Lighting metallic unit closing system |
| 10. | Road |
| 11. | Steel net |
| 12. | Pressure sensors |
| 13. | Laser barrier - Laser Sensors |
| 14. | Photovoltaic power plant |
| 15. | Switchboard panel |
| 16. | Crepuscular sensor |
| 17. | Metallic pole |

What is claimed is:

1. Automatic lighting system of the transversal markings from the pedestrian crossings, comprising:
several lighting units sank in the asphalt made of a box having an external frame and being closed with a detachable cap equipped with a window in which a protection frame is fixed of a piece made of safety glass, the cap representing the transversal marking of the pedestrian crossing, in the interior of the box being a LED lighting unit powered by a net or a photovoltaic plant mounted on a pile in the proximity of the pedestrian crossing, on the surface of the cap being poured bitumen subsequently painted with reflecting painting, so that the glass in the mounted state of the system, to be at the level of the roadway, on the supporting pile of the photovoltaic installation being a crepuscular sensor which will open the electric circuits of the LED lighting unit when reaching a certain minimum intensity of the natural light.

2. Automatic lighting system of the transversal markings for the pedestrian crossings, according to claim 1, characterized by the fact that at the longitudinal extremities of the pedestrian crossing made of the lighting units sank in asphalt, in the zone of the sidewalks, several laser sensors are provided having the role to trigger automatically the LED lighting unit the moment when a pedestrian enters the range of the mentioned sensors.

3. Automatic lighting system of the transversal markings for the pedestrian crossings, according to claim 1, characterized by the fact that the longitudinal extremities of the pedestrian crossing made of lighting units sank in the asphalt, in the zone of the sidewalks, several pressure sensors are provided, which have the role to automatically trigger the LED lighting unit the moment when a pedestrian applied pressure on them.

4. Automatic lighting system of the transversal markings for the pedestrian crossings, according to claim 1, characterized by the fact that on the supporting pile of the photovoltaic plant a control panel of the LED unit and of the cells of the photovoltaic plant is provided.

5. Automatic lighting system of the transversal markings of the pedestrian crossings according to claim 1, characterized by the fact that the security glass is sanded in order to prevent the reflex ion of light during shiny days, and by the fact that between the protection frame and the piece of sanded security glass a belt of silicone putty is put to isolate the lighting unit against water seepages.

6. Automatic lighting system of the transversal markings for the pedestrian crossings, according to claim 1, characterized by the fact that the cap of the lighting unit is provided with closing systems to allow the maintenance operations and to prevent unauthorized access inside the lighting unit.

7. Method of making the transversal markings for the pedestrian crossings, comprising the stages of:
stripping the asphalt out on all length and width of the old pedestrian crossing,
fixing on the bottom of the formed hole a netting from which the boxes of the lighting units from the composition of the automatic lighting system according to claim 1 are welded,
installing the LED lighting unit and coupling to a command panel mounted on a pile near the pedestrian crossing,
mounting, with the opportunity of detaching, of the cap of the lighting unit equipped with a central window in which a protection frame is fixed of a piece of security glass, cap which represents the transversal marking of the pedestrian crossing.
placement of bitumen on the surface of the cap of the lighting unit, between its exterior frame and the protection frame and subsequently painting with reflecting painting, so that the glass in the mounted state of the system, to be at the level of the roadway,
installing a crepuscular sensor which will open the electric circuits of the LED lighting unit when reaching a certain minimum intensity of the natural light.

8. Procedure according to claim 7, characterized by the fact that it supplementary comprises the mounting stage, at the longitudinal extremities of the pedestrian crossing made of lighting units sank in asphalt, in the area of the sidewalks, of more laser sensors that have the role of triggering the LED lighting unit automatically when a pedestrian enters the range of action of the above mentioned sensors.

9. Procedure according to claim 7, characterized by the fact that it supplementary comprises the stage of mounting, at the longitudinal extremities of the pedestrian crossing made of lighting units sank in asphalt, in the area of the sidewalks, of several pressure sensors which have the role of triggering automatically the LED lighting unit when a pedestrian applies pressure on them.
